(19) United States
(12) Patent Application Publication
(10) Pub. No.: US 2010/0085147 A1
(43) Pub. Date: Apr. 8, 2010

(54) KEYLESS ENTRY USING HAND SIGNALS

(75) Inventor: CLARK E. MCCALL, ANN ARBOR, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/247,718

(22) Filed: Oct. 8, 2008

(51) Int. Cl. B60R 25/00; G06K 9/00

(52) U.S. Cl. 340/5.72; 382/115

(57) ABSTRACT

Methods and apparatus are provided for enabling the entry by a user into a locked vehicle. An optical data sampler is configured to detect an image associated with the user. A processor is coupled to the optical data sampler and is configured to grant the user access to the vehicle if the image associated with the user substantially corresponds to a predetermined image.

### TECHNICAL FIELD

This invention relates generally to keyless entry systems, and more particularly to a keyless entry system utilizing hand signal recognition to initiate vehicular functions such as unlocking vehicle doors, trunks, and the like.

### BACKGROUND

Door-locks, trunk-locks, and the like are commonplace on vehicles such as automobiles, trucks, sport utility vehicles, etc. In some cases, access to such vehicles is based on a token or authentication device (e.g. a key, keyfob, etc.) possessed by an individual presumably authorized to enter the vehicle. For example, many vehicles are equipped with keyless entry systems that may include a portable fob having controls thereon that enable the user to unlock the vehicle's doors and perform other functions via encoded RF signals transmitted to a receiver located on the vehicle. Depending on the system, the user may also activate and deactivate alarms, turn lights on and off, and in some cases start the vehicle. Certain ones of these vehicles, luxury cars in particular, may be equipped with door mounted keyless entry systems. Such systems typically utilize a keypad positioned proximate a vehicle's door handle, thus enabling an authorized user to key in a numeric or alphanumeric code, and if the code is correct, the door or doors are automatically unlocked allowing the user to enter the vehicle. Inputting the correct code may also turn interior lights on, enable the ignition system, etc.

Unfortunately, systems that enable an individual to enter a vehicle based on what the individual possesses (e.g. a key or keyfob), have certain shortcomings. For example such tokens may be lost, borrowed, or stolen. Additionally, certain shortcomings have been noted with respect to keypads. For example, because such keypads are typically positioned on the exterior door panel of a vehicle proximate the door handle, they are visible and may be aesthetically displeasing to some. Furthermore, such keypads are accessible to unauthorized individuals and are therefore subject to being tampered with. In addition, such exteriorly mounted keyboards are exposed to the elements (i.e. dirt, rain, sunlight, etc.) that, over a period of time, may damage the keypad or otherwise reduce its operational life.

It would therefore be desirable to provide a vehicular keyless entry system that does not require (1) the use of a token (e.g., a key, keyfob, etc.) or (2) access to an externally mounted keypad in order to enter the vehicle. Other desirable features and characteristics will become apparent from the following detailed description and the appended claims, taken in conjunction with the accompanying drawings and the foregoing technical field and background.

### SUMMARY OF THE INVENTION

An apparatus is provided for enabling entry by a user into a locked vehicle. An optical data sampler is configured to detect an image associated with the user. A processor is coupled to the optical data sampler and is configured to grant the user access to the vehicle if the image associated with the user corresponds to a predetermined image.

A method is provided for enabling a user to enter a locked vehicle. The method comprises detecting an image associated with the user proximate the exterior of the vehicle, comparing the image to a predetermined image, and permitting entry into the vehicle if the detected image substantially corresponds to the predetermined image.

### DESCRIPTION OF THE DRAWINGS

The present invention will hereinafter be described in conjunction with the following drawing figures, wherein like numerals denote like elements, and:

FIG. 1 is a plan view of a vehicle (e.g. an automobile) for use in conjunction with one or more exemplary embodiments;

FIG. 2 is a block diagram of an exemplary vehicular keyless entry system utilizing hand signals and suitable for use in conjunction with the vehicle shown in FIG. 1;

FIG. 3 is an isometric view of a portion of the interior of the vehicle shown in FIG. 1 in accordance with a first exemplary embodiment;

FIG. 4 is a partial side view of the vehicle shown in FIG. 1 in accordance with a second exemplary embodiment;

FIGS. 5-11 illustrate exemplary hand signals that may be used with the keyless entry system shown in FIG. 2; and

FIG. 12 is a flowchart of an exemplary keyless entry method utilizing hand-signal recognition.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

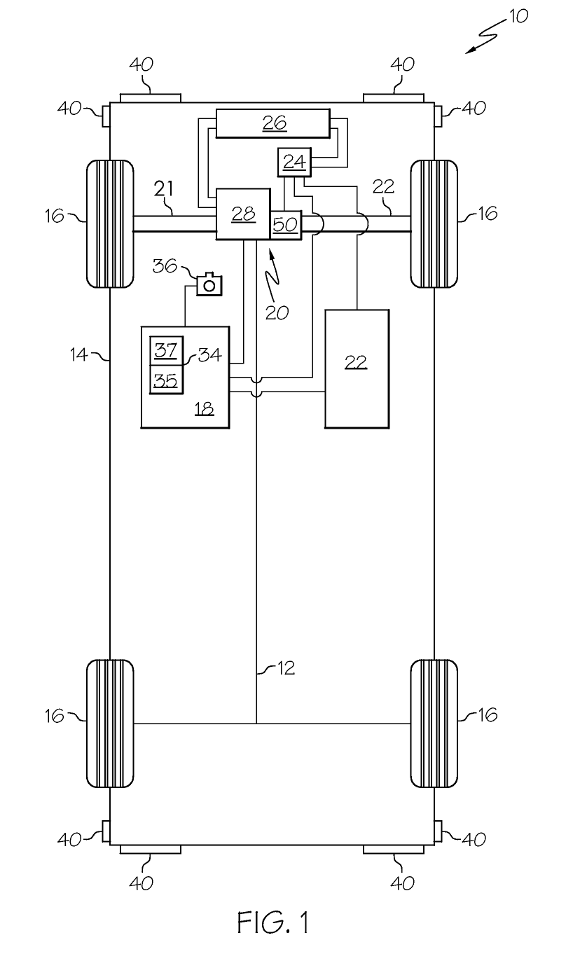

The following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment. It should also be understood that FIGS. 1-12 are merely illustrative and may not be drawn to scale.

FIG. 1 is a plan view of a vehicle (e.g., an automobile 10) for use in conjunction with one or more embodiments of the present invention. The automobile 10 includes a chassis 12, a body 14, four wheels 16, and an electronic control system (or electronic control unit (ECU)) 18. Body 14 is arranged on the chassis 12 and substantially encloses the other components of the automobile 10. Body 14 and the chassis 12 may jointly form a frame. The wheels 16 are each rotationally coupled to chassis 12 near a respective corner of body 14.

The automobile 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD). Automobile 10 may also incorporate any one of, or combination of, a number of different types of engines (or actuators), such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, or a fuel cell, a combustion/electric motor hybrid engine, and an electric motor.

In the exemplary embodiment illustrated in FIG. 1, automobile 10 may be a hybrid vehicle, and further includes an actuator assembly (or powertrain) 20, a battery 22, a power inverter (or inverter) 24, and a radiator 26. The actuator assembly 20 includes an internal combustion engine 28 and an electric motor/generator (or motor) system (or assembly) 30. Although not illustrated, power inverter 24 may include a plurality of switches, or transistors, as is commonly understood. Electric motor system 30, in one embodiment, includes one or more sinusoidally-wound, three-phase alternating current (AC) motor/generators (or motors) (e.g., permanent magnet) such as commonly used in automotive vehicles (e.g., traction drive control systems, and the like).

Still referring to FIG. 1, the combustion engine 28 and the electric motor system 30 are integrated such that both are mechanically coupled to at least some of the wheels 16 through one or more drive shafts 21. The radiator 26 is connected to the frame at an outer portion thereof and although not illustrated in detail, includes multiple cooling channels therethrough that contain a cooling fluid (i.e., coolant) such as water and/or ethylene glycol (i.e., “antifreeze”) and is coupled to the engine 28 and the inverter 24. Inverter 24 receives and shares coolant with the electric motor 30. Radiator 26 may be similarly connected to the inverter 24 and/or the electric motor 30.

The electronic control system 18 is in operable communication with actuator assembly 20, battery 22, and inverter 24. Although not shown in detail, the electronic control system 18 includes various sensors and automotive control modules, or electronic control units (ECUs), such as a body control module (BCM) 34, including at least one processor 37 and/or a memory 35 that stores instructions, preferences, and information representative of hand signals or gestures and/or sequences of hand signals for carrying out the processes and methods described below. The automobile 10 further includes camera 36 coupled to BCM 34, and various lights 40 in operable communication with the electronic control system 18

The lights (or lamps) 40 are positioned on an outer portion of the body 14, and although not shown as such, are in operable communication with the electronic control system 18 (or the BCM 34). The lights 40 may include, for example, head lights on the front of the automobile 10, tail lights on the rear of the automobile 10, and signal lights on lateral sides of the automobile 10.

During operation, still referring to FIG. 1, the automobile 10 is operated by providing power to the wheels 16 with the combustion engine 28 and the electric motor 30 in an alternating manner and/or with the combustion engine 28 and the electric motor 30 simultaneously. In order to power the electric motor 30, direct current (DC) power is provided from the battery 22 to the inverter 24, which converts the DC power to AC power, prior to energizing the electric motor 30.

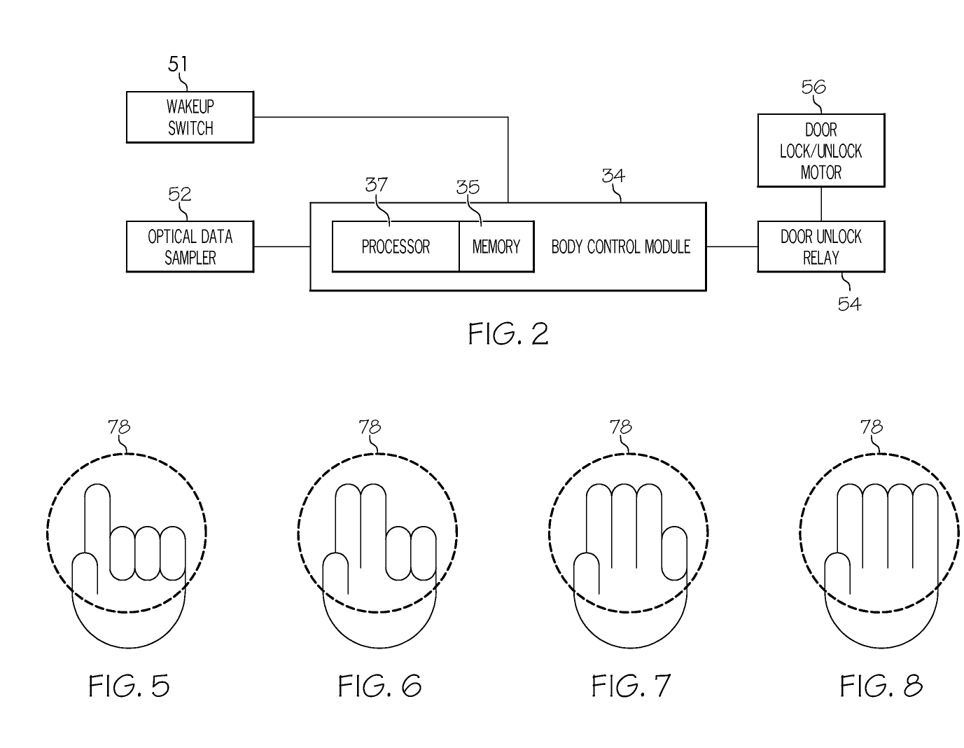

FIG. 2 is a block diagram of a vehicular keyless entry system suitable for use in conjunction with the vehicle shown in FIG. 1. Like elements are denoted with like reference numerals. As can be seen, body control module (BCM) 34 includes a memory 35 and an image processor 37. BCM 34 has a first input coupled to a wakeup switch 51 (shown in FIG. 4 as being incorporated into door handle 60) and a second input coupled to an optical data sampler 52. A door-unlock relay 54 receives an activation signal from BCM 34 when processor 37 identifies an appropriate image (i.e., a hand signal or series of hand signals) displayed by or associated with an individual within the field-of-view of optical data sampler 52 in order to gain entry to a vehicle. When the appropriate image is detected, BCM 34 activates door-unlock relay 54 causing door lock/unlock motor 56 to unlock at least one door.

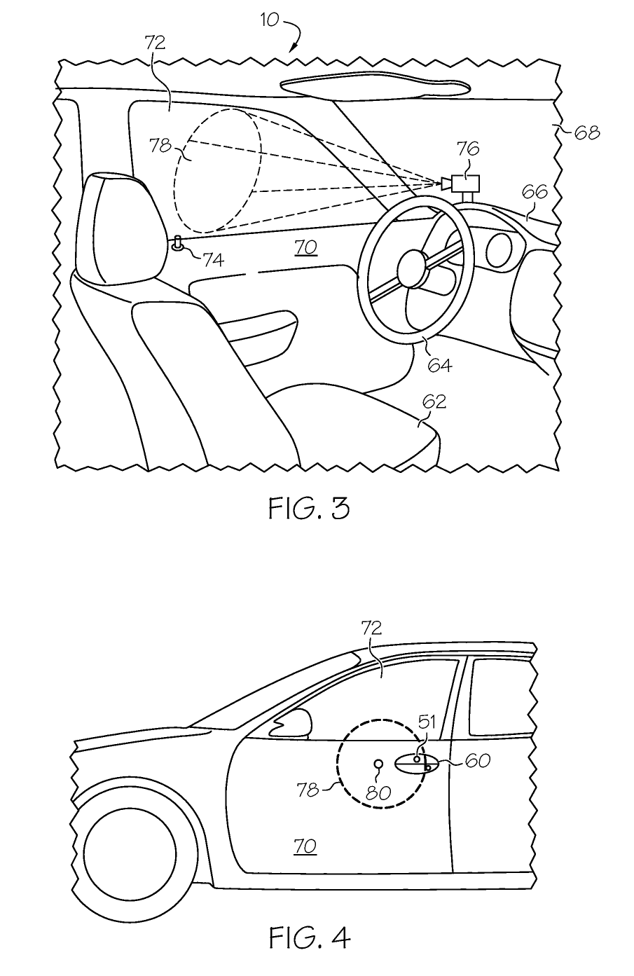

Optical data sampler 52 may comprise a camera having a field-of-view that extends to the exterior of the vehicle. For example, FIG. 3 is an isometric view of a portion the exterior of vehicle 10. As is customary, vehicle 10 comprises, in part, a driver's seat 62, a steering assembly or wheel 64, a dashboard 66, a windshield 68, and a driver's-side door 70 equipped with a driver's-side window 72 and a door-lock button 74 that is operatively coupled to door lock/unlock motor 56 (FIG. 2) in the conventional manner. An optical data sampler in the form of a camera 76 is mounted on dashboard 66 in such a manner so as to have an operative field-of-view 78 that extends to the exterior of vehicle 10 through window 72. Thus, the optical data sampler (e.g. camera 76) is able to capture optical data associated with a hand signal or series of hand signals performed within field-of-view 78 by an individual desiring access to vehicle 10.

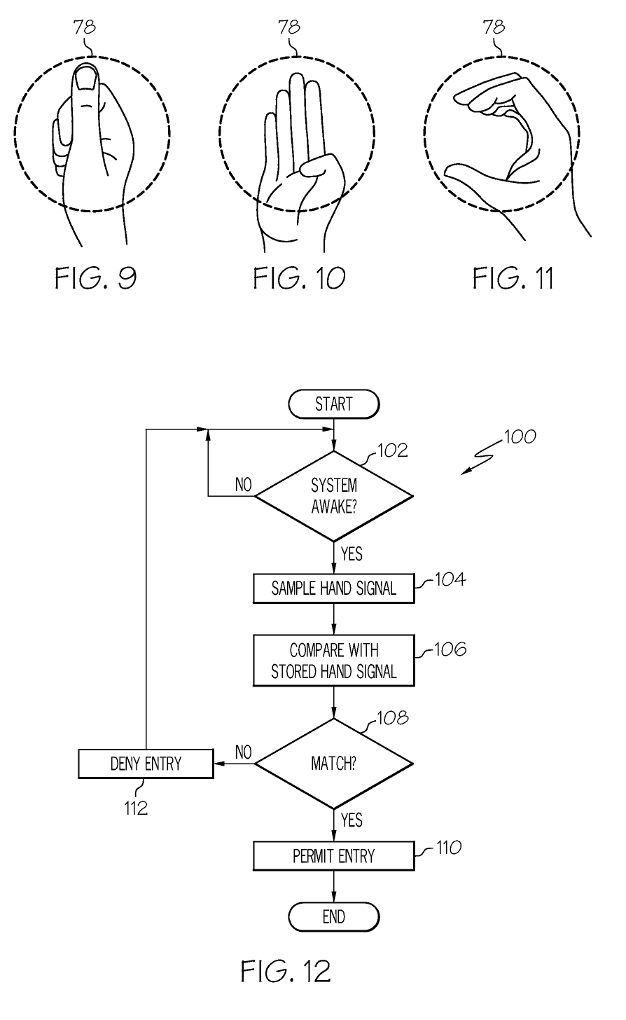

FIGS. 5-8 illustrate four exemplary hand signals that may be displayed by a user singly or in a series and that may be recognized by image processor 37 (FIG. 2) as an authorized hand signal(s) permitting the displayer to enter the vehicle. As shown, FIGS. 5, 6, 7, and 8, taken in series, could be considered to represent a code 1-2-3-4. Using only the four hand signals shown in FIGS. 5-8, a plurality of possible authorized one-digit, two-digit, three-digit, and four-digit codes are possible. It should be clear, however, that hand signals need not be limited to numeric representations. For example, one-handed or two-handed signs, commonly utilized by the hearing-impaired, may be utilized to form the keyless entry codes. Examples of such signs are shown in FIGS. 9, 10, and 11 and correspond to the letters A, B, and C respectively. It is to be understood, however, that it is the shape of the hand signal image itself that is analyzed to determine if it corresponds to a predetermined pattern stored in memory 35 (FIG. 2).

While the optical data sampler is shown FIG. 2 as being mounted on dashboard 66 and having a field-of-view 78 that extends through side window 72, it should be recognized that the location of optical data sampler 52 is not critical as long as it's field-of-view extends to the proximate exterior of the vehicle, preferably near the driver-side door. For example, optical data sampler 52 (e.g. camera 76) may be mounted in driver-side door 70 and have a field-of-view 78 that extends through an aperture 80 in door 70 as is shown in FIG. 4. Also, a direct line-of-sight between optical data sampler 52 and the originator of the hand signals is not required since optical transmission may be accomplished through a combination of lenses and/or mirrors. Thus, optical data sampler may be situated at other convenient locations.

Data from optical data sampler 52, corresponding to an image associated with a user (e.g., a hand signal) within field-of-view 78 (FIG. 3), is provided to BCM 34 where it is processed by image processor 37. A variety of processing techniques, for example those based on a Hidden Markov Model, may form the basis of a hand-signal recognition algorithm implemented within and carried out by image processor 37. Processor 37 processes images captured by optical data sampler 52 and then compares data points associated with such images with patterns of data points stored in memory 35 associated with known images (i.e. images of hand signals that must be displayed by a user to gain entry to the vehicle). When processor recognizes a hand signal, or multiple hand signals as the case may be (i.e. determines that the displayed hand signal(s) substantially corresponds or matches the predetermined hand signal(s) stored in memory 35), BCM 34 sends a signal to door-unlock relay 54 which in turn signals door lock/unlock motor 56 to unlock the vehicle door.

FIG. 12 is a flowchart of an exemplary method 100 for vehicular keyless entry utilizing hand signals. After determining that the system is activated (i.e. “awake”) (step 102), an image associated with a user (e.g., a hand-signal or series of hand signals made by the user) within the field-of-view 78 (FIG. 3) of optical data sampler 52 (FIG. 2) is detected and sampled (step 104). The sample data is then transmitted to processor 37 wherein the sample data is compared to data stored in memory 35 corresponding to a predetermined authorized image (e.g., hand signal(s)) (step 106). If it is determined that there is a substantial match between the image associated with the user and the predetermined authorized image (step 108), entry to the vehicle is permitted (step 110). If there is no match, entry is denied (step 112).

Thus, the above described keyless entry system permits a vehicle owner to leave a vehicle in a secure mode and yet easily gain access to the vehicle without carrying an authentication device (e.g. key, keyfob, etc.) that may be lost or stolen. Of course, the above description is given by way of example only, and changes in form and details may be made by the skilled practitioner. For example, wakeup switch 50 may be located at any convenient location utilizing various technologies; e.g. touch, proximity, etc. In addition, it should be clear that the above techniques may be utilized to lock and unlock multiple doors in addition to trunk doors, tailgates, rear door panels, and the like. One or more optical data samplers may be employed each having a different field-of-view for carrying out different functions.

What is claimed is:

1. A keyless entry system for providing entry by a user into a vehicle, the system comprising:
an optical data sampler configured to detect an image associated with the user; and
a processor coupled to the optical data sampler and configured to grant the user access to the vehicle if the image associated with the user substantially corresponds to a predetermined image.

2. A system according to claim 1 wherein the predetermined image associated with the user is a hand signal.

3. A system according to claim 1 wherein the optical data sampler is configured to detect a predetermined sequence of hand signals.

4. A system according to claim 3 wherein the predetermined sequence of hand signals corresponds to a predetermined sequence of numbers.

5. A system according to claim 1 wherein the optical data sampler is a camera mounted inside the vehicle.

6. A system according to claim 5 wherein the camera has a field-of-view that extends outside the vehicle.

7. A system according to claim 6 wherein the vehicle comprises a side window and wherein the camera has a field-of-view that extends through the side window.

8. A system according to claim 1 wherein the vehicle comprises a side door and wherein the optical data sampler is mounted in the side door.

9. A system according to claim 8 wherein the optical data sampler has a field-of-view that extends proximate the exterior of the vehicle.

10. A system according to claim 1 wherein the vehicle comprises a door lock coupled to the processor and wherein the door lock is activated by the processor.

11. A keyless entry system for permitting entry by a user into a vehicle, the system comprising:
a camera mounted on the vehicle and configured to detect an image made by the user outside the vehicle; and
a processor coupled to the processor and configured to compare the image made by the user with a predetermined stored image, and permit access to the vehicle if the image made by the user substantially corresponds to the predetermined stored image.

12. A system according to claim 11 wherein the image made by the user comprises a predetermined sequence of hand signals.

13. A system according to claim 12 wherein the camera is mounted inside the vehicle and has a field-of-view that extends outside the vehicle.

14. A system according to claim 12 wherein the vehicle includes a door and wherein the camera is mounted in the door with a field-of-view extending outside the vehicle.

15. A system according to claim 11 wherein the vehicle comprises a door lock coupled to the processor and wherein the door lock is activated by the processor.

16. A method for enabling a user to enter a vehicle, the method comprising:
detecting an image associated with the user proximate the exterior of the vehicle;
comparing the image associated with the user to a predetermined image; and
permitting entry into the vehicle if the image associated with the user substantially corresponds to the predetermined image.

17. A method according to claim 16 wherein the step of detecting comprises detecting a hand signal.

18. A method according to claim 17 wherein the step of detecting comprises detecting a predetermined sequence of hand signals.

19. A method according to claim 18 wherein the predetermined sequence of hand signals corresponds to a predetermined sequence of numbers.

20. A method according to claim 17 wherein the step of detecting comprises comparing the hand signal with a plurality of stored hand signals.
